(19) United States
(12) Patent Application Publication
(10) Pub. No.: US 2024/0319528 A1
(43) Pub. Date: Sep. 26, 2024

(54) LIGHT ADJUSTMENT DEVICE AND PANEL UNIT

(71) Applicant: Japan Display Inc., Tokyo (JP)

(72) Inventors: Koichi NAGAO, Tokyo (JP); Takeo KOITO, Tokyo (JP)

(21) Appl. No.: 18/672,387

(22) Filed: May 23, 2024

Related U.S. Application Data
(63) Continuation of application No. PCT/JP2022/042767, filed on Nov. 17, 2022.

(30) Foreign Application Priority Data
Dec. 2, 2021 (JP) 2021-196135

(51) Int. Cl. G02F 1/1333; G02F 1/1347

(52) U.S. Cl. CPC G02F 1/133308; G02F 1/1347; G02F 2201/38; G02F 2202/28

(57) ABSTRACT

A light adjustment device includes a panel unit in which a plurality of light adjustment panels each including a first substrate and a second substrate overlapping the first substrate on one side in a first direction intersecting the first substrate are stacked in the first direction, an optical sheet bonded to the light adjustment panels in a state of overlapping the light adjustment panels, and a light source positioned on another side relative to the panel unit in the first direction. The optical sheet is bonded to at least one of the second substrate of a first light adjustment panel positioned furthest to the one side in the first direction in the panel unit and the first substrate of a second light adjustment panel positioned furthest to the other side in the first direction.

### CROSS-REFERENCE TO RELATED APPLICATION

This application is a continuation of International Patent Application No. PCT/JP2022/042767 filed on Nov. 17, 2022 which designates the United States, incorporated herein by reference, and which claims the benefit of priority from Japanese Patent Application No. 2021-196135 filed on Dec. 2, 2021, incorporated herein by reference.

### BACKGROUND

### 1. Technical Field

The present disclosure relates to a light adjustment device and a panel unit.

### 2. Description of the Related Art

A light adjustment device of Japanese Patent Application Laid-open Publication No. 2004-333567 includes a light adjustment panel. The light adjustment panel includes a plurality of substrates and a liquid crystal layer encapsulated between the substrates. When incident light enters the light adjustment panel, the light transmittance of the incident light is adjusted in the light adjustment panel and this adjusted transmitted light is output from the light adjustment device.

When a light adjustment device attached to a ceiling or the like falls and hits a floor surface, it is possible that the light adjustment device is damaged and damaged components scatter.

### SUMMARY

A light adjustment device according to an embodiment of the present disclosure includes a panel unit in which a plurality of light adjustment panels each including a first substrate and a second substrate overlapping the first substrate on one side in a first direction intersecting the first substrate are stacked in the first direction, an optical sheet bonded to the light adjustment panels in a state of overlapping the light adjustment panels, and a light source positioned on another side relative to the panel unit in the first direction. The optical sheet is bonded to at least one of the second substrate of a first light adjustment panel positioned furthest to the one side in the first direction in the panel unit and the first substrate of a second light adjustment panel positioned furthest to the other side in the first direction.

A panel unit according to an embodiment is disclosed. In the panel unit, a plurality of light adjustment panels each including a first substrate and a second substrate overlapping the first substrate on one side in a first direction intersecting the first substrate are stacked in the first direction, the first substrate is formed larger than the second substrate in a plan view, the plurality of light adjustment panels include a third light adjustment panel and a fourth light adjustment panel adjacent to each other in the first direction, and the fourth light adjustment panel is disposed on one side relative to the third light adjustment panel in the first direction, the panel unit includes a bonding layer that joins the second substrate of the third light adjustment panel and the first substrate of the fourth light adjustment panel, and the bonding layer is provided on an entire surface of the first substrate of the fourth light adjustment panel.

### BRIEF DESCRIPTION OF THE DRAWINGS

FIG. 1 is a schematic diagram of a light adjustment panel according to a first embodiment when viewed from the upper side;

FIG. 2 is a schematic diagram of a front surface of an array substrate according to the first embodiment when viewed from the upper side;

FIG. 3 is a schematic diagram of a counter substrate according to the first embodiment when turned over, illustrating its front surface on which wires are provided;

FIG. 4 is a sectional view along line IV-IV in FIG. 2;

FIG. 5A is a schematic diagram illustrating a section of a light adjustment device of the first embodiment;

FIG. 5B is a schematic diagram illustrating a section of a light adjustment device according to a modification;

FIG. 6 is a schematic diagram illustrating a section of a light adjustment device of a second embodiment;

FIG. 7 is a schematic diagram illustrating a section of a light adjustment device of a third embodiment;

FIG. 8 is a schematic diagram illustrating a section of a light adjustment device according to another modification;

FIG. 9 is a schematic diagram illustrating a section of a light adjustment device according to still another modification;

FIG. 10 is a schematic diagram illustrating a section of a light adjustment device according to still another modification; and

FIG. 11 is a schematic diagram illustrating a section of a light adjustment device according to still another modification.

### DETAILED DESCRIPTION

Aspects (embodiments) of the present disclosure will be described below in detail with reference to the accompanying drawings. Contents described below in the embodiments do not limit the present disclosure. Components described below include those that could be easily thought of by the skilled person in the art and those identical in effect. Components described below may be combined as appropriate.

What is disclosed herein is merely exemplary, and any modification that could be easily thought of by the skilled person in the art as appropriate without departing from the gist of the disclosure is contained in the scope of the present disclosure. For clearer description, the drawings are schematically illustrated for the width, thickness, shape, and the like of each component as compared to an actual aspect in some cases, but the drawings are merely exemplary and do not limit interpretation of the present disclosure. In the present specification and drawings, any element same as that already described with reference to an already described drawing is denoted by the same reference sign, and detailed description thereof is omitted as appropriate in some cases.

In an XYZ coordinate system illustrated in the drawings, an X direction is the right-left direction, and an X1 side is opposite an X2 side. The X1 side is also referred to as a left side, and the X2 side is also referred to as a right side. A Y direction is the front-back direction, and a Y1 side is opposite a Y2 side. The Y1 side is also referred to as a front side, and the Y2 side is also referred to as a back side. A Z direction is the up-down direction (stacking direction). A Z1 side is opposite a Z2 side. The Z1 side is also referred to as an upper side, and the Z2 side is also referred to as a lower side. The Z direction is also referred to as a first direction, and the X and Y directions are also referred to as a second direction. The Z2 side is also referred to as one side in the first direction, and the Z1 side is also referred to as the other side in the first direction.

### First Embodiment

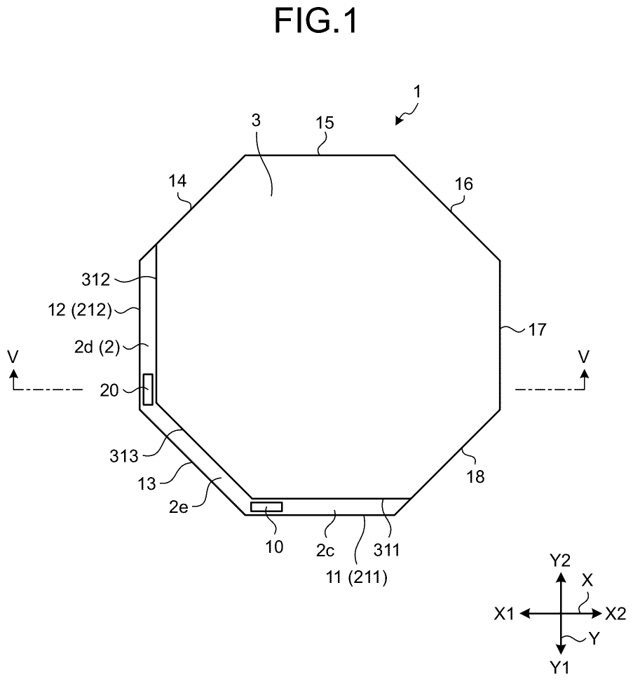

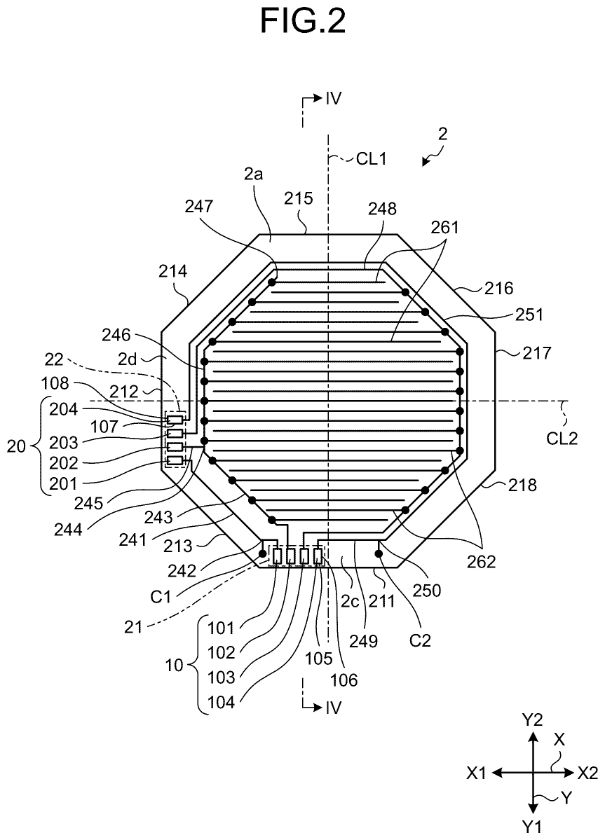

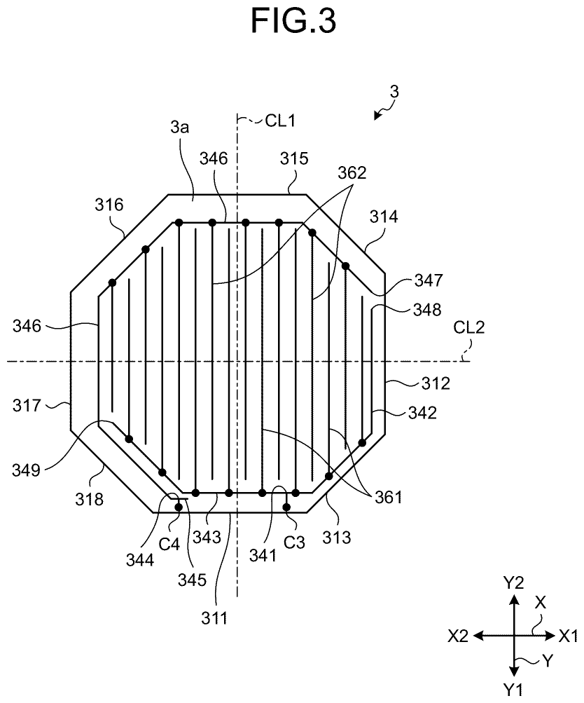

First, a light adjustment device according to a first embodiment will be described below. FIG. 1 is a schematic diagram of a light adjustment panel according to the first embodiment when viewed from the upper side. FIG. 2 is a schematic diagram of the front surface of an array substrate according to the first embodiment when viewed from the upper side. FIG. 3 is a schematic diagram of a counter substrate according to the first embodiment when turned over, illustrating its front surface on which wires are provided.

As illustrated in FIG. 1, each light adjustment panel 1 includes an array substrate (first substrate) 2 and a counter substrate (second substrate) 3 disposed on the upper side of the array substrate 2. Each light adjust panel 1 is a regular octagon in a plan view and has a first side 11, a second side 12, a third side 13, a fourth side 14, a fifth side 15, a sixth side 16, a seventh side 17, and an eighth side 18. In the present invention, the shape of the light adjustment panel 1 is not particularly limited, and polygons other than octagons as well as circles and ellipses are included in the present invention.

The first side 11 is positioned on the Y1 side on the light adjustment panel 1. The first side 11 is parallel to the X direction in the drawing. The first side 11 of the light adjustment panel 1 matches a first side 211 of the array substrate 2 illustrated in FIG. 2. However, a first side 311 of the counter substrate 3 illustrated in FIG. 3 is positioned on the Y2 side relative to the first side 211 of the array substrate 2. Thus, as illustrated in FIG. 1, an end part 2c of the array substrate 2 on the Y1 side is exposed when the counter substrate 3 is stacked on the upper side relative to the array substrate 2. A first terminal group 10 is provided at the end part 2c.

The second side 12 is positioned on the X1 side on the light adjustment panel 1. The second side 12 is parallel to the Y direction in the drawing. The second side 12 of the light adjustment panel 1 matches a second side 212 of the array substrate 2 illustrated in FIG. 2. However, a second side 312 of the counter substrate 3 illustrated in FIG. 3 is positioned on the X2 side relative to the second side 212 of the array substrate 2. Thus, as illustrated in FIG. 1, an end part 2d of the array substrate 2 on the X1 side is exposed when the counter substrate 3 is stacked on the upper side relative to the array substrate 2. A second terminal group 20 is provided at the end part 2d.

The third side 13 intersects both the X1 direction and the Y1 direction. The angle of the intersection is 45°. The third side 13 matches a third side 213 of the array substrate 2 illustrated in FIG. 2. However, a third side 313 of the counter substrate 3 illustrated in FIG. 3 is positioned on the X2 and Y2 side relative to the third side 213 of the array substrate 2. In other words, in a plan view, the third side 313 of the counter substrate 3 is positioned on a center C side relative to the third side 213 of the array substrate 2. Thus, as illustrated in FIG. 1, an end part 2e of the array substrate 2 is exposed when the counter substrate 3 is stacked on the upper side relative to the array substrate 2.

The fourth side 14 intersects both the X1 direction and the Y2 direction. The angle of the intersection is 45°. The fourth side 14 overlaps a fourth side 214 of the array substrate 2 illustrated in FIG. 2 and a fourth side 314 of the counter substrate 3 illustrated in FIG. 3.

The fifth side 15 is positioned on the Y2 side on the light adjustment panel 1. The fifth side 15 overlaps a fifth side 215 of the array substrate 2 illustrated in FIG. 2 and a fifth side 315 of the counter substrate 3 illustrated in FIG. 3.

The sixth side 16 intersects both the X2 direction and the Y2 direction. The angle of the intersection is 45°. The sixth side 16 overlaps a sixth side 216 of the array substrate 2 illustrated in FIG. 2 and a sixth side 316 of the counter substrate 3 illustrated in FIG. 3.

The seventh side 17 is positioned on the X2 side on the light adjustment panel 1. The seventh side 17 overlaps a seventh side 217 of the array substrate 2 illustrated in FIG. 2 and a seventh side 317 of the counter substrate 3 illustrated in FIG. 3.

The eighth side 18 intersects both the X2 direction and the Y1 direction. The angle of the intersection is 45°. The eighth side 18 overlaps an eighth side 218 of the array substrate 2 illustrated in FIG. 2 and an eighth side 318 of the counter substrate 3 illustrated in FIG. 3.

Accordingly, the area of the counter substrate 3 is smaller than the area of the array substrate 2, and thus the first terminal group 10 provided at the end part 2c of the array substrate 2 and the second terminal group 20 provided at the end part 2d of the array substrate 2 are exposed.

The following describes the array substrate 2 and the counter substrate 3 with reference to FIGS. 2 and 3. FIG. 3 is a schematic diagram illustrating a front surface 3a on which wires are provided among the front and back surfaces of the counter substrate 3. Accordingly, the X1 and X2 directions of the counter substrate 3 in FIG. 3 are opposite the X1 and X2 directions of the array substrate 2 in FIG. 2. FIG. 2 illustrates a central line CL1 extending in the Y direction through the center of the array substrate 2 in the X direction, and a central line CL2 extending in the X direction through the center of the array substrate 2 in the Y direction. As illustrated in FIG. 2, at the end part 2c along the first side 211 of the array substrate 2, the first terminal group 10 is provided at a first end part 21 (illustrated with dashed and double-dotted lines) on a side closer to the second side 212 (or the third side 213) with respect to the center of the first side 211. In other words, the end part 2c is an end part of the array substrate 2 on the Y1 side, and the first end part 21 illustrated with dashed and double-dotted lines is disposed on the X1 side of the central line CL1 among sites of the end part 2c. The first terminal group 10 is provided at the first end part 21. As illustrated in FIG. 2, the first terminal group 10 includes a first terminal 101, a second terminal 102, a third terminal 103, and a fourth terminal 104. The first terminal 101, the second terminal 102, the third terminal 103, and the fourth terminal 104 are sequentially arranged in the X direction (fourth direction) from the X1 side toward the X2 side. The terminals 101 to 104 each have a pair of short sides 105 parallel to the first side 211 and a pair of long sides 106 parallel to the second side 212.

In addition, as illustrated in FIG. 2, at the end part 2d along the second side 212 of the array substrate 2, the second terminal group 20 is provided at a second end part 22 (illustrated with dashed and double-dotted lines) on a side closer to the first side 211 (or the third side 213) with respect to the center of the second side 212. In other words, the end part 2d is an end part of the array substrate 2 on the X1 side, and the second end part 22 illustrated with dashed and double-dotted lines is disposed on the Y1 side of the central line CL2 among sites of the end part 2d. The second terminal group 20 is provided at the second end part 22. As illustrated in FIG. 2, the second terminal group 20 includes a fifth terminal 201, a sixth terminal 202, a seventh terminal 203, and an eighth terminal 204. The fifth terminal 201, the sixth terminal 202, the seventh terminal 203, and the eighth terminal 204 are sequentially arranged in the front-back direction (Y direction) from the Y1 side toward the Y2 side. The terminals 201 to 204 each have a pair of long sides 107 parallel to the first side 211 and a pair of short sides 108 parallel to the second side 212.

The following describes wiring of the array substrate 2 and the counter substrate 3. Wires are provided on the front surface of each substrate among the front and back surfaces thereof. In other words, a surface on which wires are provided is referred to as the front surface, and a surface opposite to the front surface is referred to as the back surface.

As illustrated in FIG. 2, wires, liquid crystal drive electrodes, and coupling portions are provided on a front surface 2a of the array substrate 2. A coupling portion C1 of the array substrate 2 and a coupling portion C3 of the counter substrate 3 (refer to FIG. 3) are electrically coupled to each other through a conductive pillar (not illustrated) through which conduction is possible. Similarly, a coupling portion C2 of the array substrate 2 and a coupling portion C4 of the counter substrate 3 (refer to FIG. 3) are electrically coupled to each other through a common electrode (not illustrated) through which conduction is possible.

The first terminal 101 and the fifth terminal 201 are electrically coupled to each other through a wire (first wire) 241. A bifurcation point 242 is provided halfway through the wire 241, and a wire extends from the bifurcation point 242 to the coupling portion C1.

The second terminal 102 and the sixth terminal 202 are electrically coupled to each other through wires (second wires) 243 and 245. A bifurcation point 244 is provided on the wire 243, and a wire 246 extends from the bifurcation point 244 to an end 247.

The third terminal 103 and the seventh terminal 203 are electrically coupled to each other through a wire (third wire) 248. The fourth terminal 104 and the eighth terminal 204 are electrically coupled to each other through wires (fourth wires) 249 and 251. The wire 249 extends up to a bifurcation point 250 from the fourth terminal 104 toward the X2 side. The wire 251 extends from the bifurcation point 250 to the eighth terminal 204. A wire extends from the bifurcation point 250 to the coupling portion C2.

A plurality of liquid crystal drive electrodes 261 are coupled to the wires 243 and 246. The liquid crystal drive electrodes 261 extend straight in the X direction. The liquid crystal drive electrodes 261 are disposed at equal intervals in the Y direction.

A plurality of liquid crystal drive electrodes 262 are coupled to the wire 248. The liquid crystal drive electrodes 262 extend straight in the X direction. The liquid crystal drive electrodes 262 are disposed at equal intervals in the Y direction. The liquid crystal drive electrodes 261 and 262 are alternately arranged in the Y direction.

As illustrated in FIG. 3, wires, liquid crystal drive electrodes, and coupling portions are provided on the front surface 3a of the counter substrate 3. The central lines CL1 and CL2 illustrated in FIG. 3 correspond to the central lines CL1 and CL2 illustrated in FIG. 2.

The coupling portion C3 is coupled to wires 342 and 343 through a bifurcation point 341. The wire 342 extends to an end 348. The wire 343 extends to an end 349. The coupling portion C4 is coupled to wires 345 and 346 through a bifurcation point 344. The wire 346 extends to an end 347.

A plurality of liquid crystal drive electrodes 361 are coupled to the wires 342 and 343. The liquid crystal drive electrodes 361 extend straight in the Y direction. The liquid crystal drive electrodes 361 are disposed at equal intervals in the X direction.

A plurality of liquid crystal drive electrodes 362 are coupled to the wire 346. The liquid crystal drive electrodes 362 extend straight in the Y direction. The liquid crystal drive electrodes 362 are disposed at equal intervals in the X direction. The liquid crystal drive electrodes 361 and 362 are alternately arranged in the X direction.

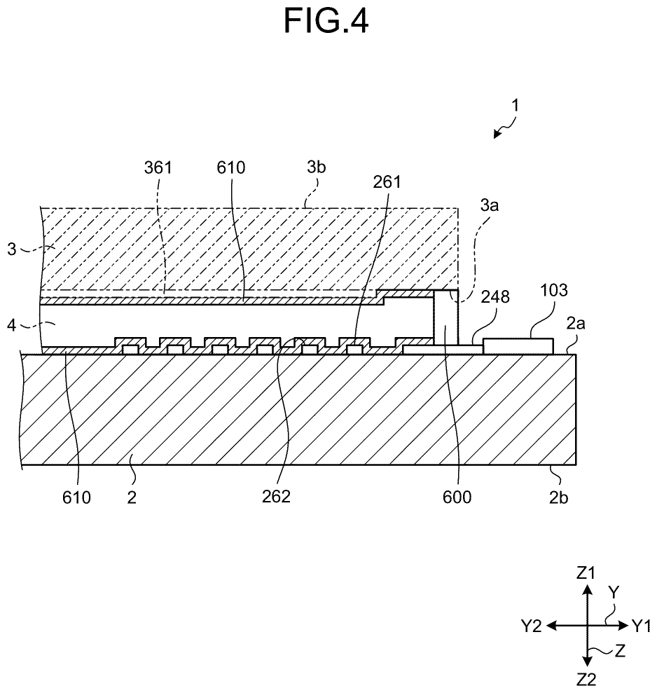

The following briefly describes a sectional structure of each light adjustment panel 1. FIG. 4 is a sectional view taken along line IV-IV in FIG. 2. As illustrated in FIG. 4, the light adjustment panel 1 includes the array substrate 2, the counter substrate 3, and a liquid crystal layer 4. As illustrated in FIG. 4, the counter substrate 3 is disposed on the upper side (Z1 side) of the array substrate 2. The liquid crystal layer 4 is provided between the counter substrate 3 and the array substrate 2. Specifically, the front surface 2a of the array substrate 2 and the front surface 3a of the counter substrate 3 face each other with the liquid crystal layer 4 interposed therebetween. The array substrate 2 has a back surface 2b opposite the front surface 2a, and the counter substrate 3 has a back surface 3b opposite the front surface 3a. Since the area of the counter substrate 3 is smaller than the area of the array substrate 2 as described above, the third terminal 103 provided on the front surface 2a of the array substrate 2 is exposed. An insulating layer, which is provided to prevent contact between two wires, is not provided in the light adjustment panel 1 according to the present embodiment because no wires on the array substrate 2 overlap each other.

In addition, alignment films 610 are stacked on both substrates and the electrodes as illustrated in FIG. 4. Specifically, one of the alignment films 610 is stacked on the front surface 2a of the array substrate 2 and the upper surfaces of the liquid crystal drive electrodes 261 and 262, and part of the third wire 248. The other alignment film 610 is stacked on the front surface 3a of the counter substrate 3 and the upper surfaces of the liquid crystal drive electrodes 361. The array substrate 2 and the counter substrate 3 are bonded to each other by a seal 600 enclosing an effective region, and the liquid crystal layer 4 fills a space formed by the seal 600.

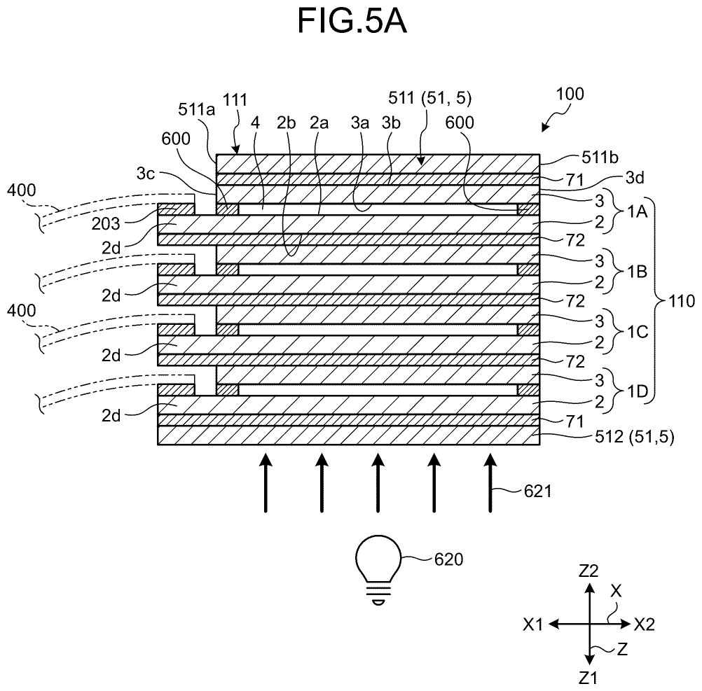

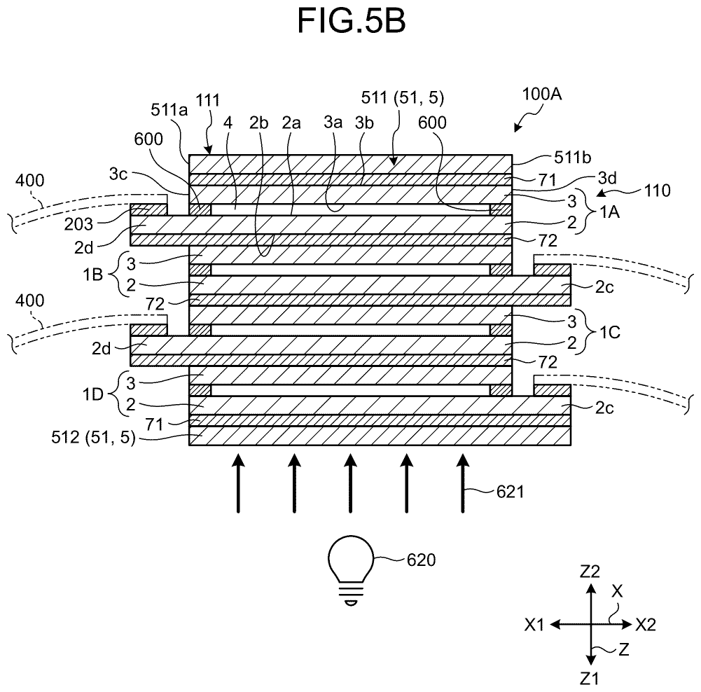

The following describes the light adjustment device of the first embodiment. FIG. 5A is a schematic diagram illustrating a section of the light adjustment device of the first embodiment.

As illustrated in FIG. 5A, a light adjustment device 100 according to the first embodiment includes a panel unit 110, optical sheets 5, and a light source 620. A device body 111 includes the panel unit 110 and the optical sheets 5. In the light adjustment device 100 according to the present embodiment, liquid crystal cells for p-wave polarization and liquid crystal cells for s-wave polarization are stacked and combined.

The panel unit 110 is formed by stacking a plurality of light adjustment panels 1 in the Z direction (first direction). In the present embodiment, a plurality (in the embodiment, four) of light adjustment panels 1 illustrated in FIG. 1 are stacked. Specifically, as illustrated in FIG. 5A, the four light adjustment panels 1 are light adjustment panels 1A, 1B, 1C, and 1D stacked in order from the upper side. The light adjustment panel 1A is also referred to as a first light adjustment panel. The light adjustment panel 1A is disposed furthest to the upper side among the four light adjustment panels 1. In other words, the light adjustment panel 1A is positioned furthest to the Z2 side (one side in the first direction) among the plurality of light adjustment panels. The light adjustment panel 1D is also referred to as a second light adjustment panel. The light adjustment panel 1D is disposed furthest to the lower side among the four light adjustment panels 1. In other words, the light adjustment panel 1D is positioned furthest to the Z1 side (the other side in the first direction) among the plurality of light adjustment panels. The light adjustment panels 1B and 1C are stacked between the light adjustment panels 1A and 1D.

The light adjustment panels 1A, 1B, 1C, and 1D are bonded to each other through a second bonding layer (bonding layer) 72. In other words, all light adjustment panels adjacent to each other in the Z direction (first direction) are bonded to each other through the second bonding layer (bonding layer) 72. When two light adjustment panels adjacent to each other in the Z direction are, for example, the light adjustment panel 1B (fourth light adjustment panel) and the light adjustment panel 1C (third light adjustment panel), the back surface 2b of the array substrate 2 in the light adjustment panel 1B (fourth light adjustment panel) and the back surface 3b of the counter substrate 3 in the light adjustment panel 1C (third light adjustment panel) are bonded to each other through the second bonding layer 72. Similarly, the light adjustment panel 1A and the light adjustment panel 1B are bonded to each other through the second bonding layer 72, and the light adjustment panel 1C and the light adjustment panel 1D are bonded to each other through the second bonding layer 72.

Each second bonding layer 72 is provided across the entire surface of a substrate (the array substrate 2 or the counter substrate 3) in each of the light adjustment panels 1A, 1B, 1C, and 1D. For example, in the light adjustment panel 1B (fourth light adjustment panel), the second bonding layer 72 is provided on the entire surface of the back surface 2b of the array substrate 2. Specifically, the second bonding layer 72 is provided from an end of the back surface 2b of the array substrate 2 on the X2 side to an end thereof on the X1 side in the X direction and from an end of the back surface 2b of the array substrate 2 on the Y1 side to an end thereof on the Y2 side in the Y direction. In the light adjustment panel 1C (third light adjustment panel), the second bonding layer 72 is provided on the entire surface of the back surface 3b of the counter substrate 3. Specifically, the second bonding layer 72 is provided from an end of the back surface 3b of the counter substrate 3 on the X2 side to an end thereof on the X1 side in the X direction and from an end of the back surface 3b of the counter substrate 3 on the Y1 side to an end thereof on the Y2 side in the Y direction. In this manner, the second bonding layers 72 are provided on the entire surface of the counter substrate 3 of the third light adjustment panel and the entire surface of the array substrate 2 of the fourth light adjustment panel.

Since the array substrate 2 is larger than the counter substrate 3, the end part 2d of the array substrate 2 on the X1 side is a frame region not overlapping the counter substrate 3 in the Z direction. Each second bonding layer 72 extends to the frame region outside the effective region. The lower surface of each second bonding layer 72 provided in the frame region is exposed, whereas the front surface thereof is cured to some extent.

The optical sheets 5 in the first embodiment are, for example, antireflection films 51 made of resin. Specifically, an antireflection film 511 is bonded to the back surface 3b of the counter substrate 3 in the light adjustment panel 1A through a first bonding layer 71. An antireflection film 512 is bonded to the back surface 2b of the array substrate 2 in the light adjustment panel 1D through another first bonding layer 71. The first bonding layers 71 and the second bonding layers 72 are, for example, optical clear resin (OCR) or optical clear adhesive (OCA). The first bonding layers 71 and the second bonding layers 72 may have conductivity. The size of each optical sheet 5 is substantially equal to the size of a surface to which the optical sheet 5 is bonded. In other words, the edges of each optical sheet 5 extend along the edges of a surface to which the optical sheet 5 is bonded. Furthermore, when viewed in the Z direction, the edges of each optical sheet 5 are so close to the edges of a substrate surface to which the optical sheet 5 is bonded that the edges of the optical sheet 5 overlap or can be considered to overlap the edges of the substrate surface. For example, as illustrated in FIG. 5A, the position of an edge 511a of the antireflection film 511 on the X1 side in the X direction matches the position of an edge 3c of the counter substrate 3 on the X1 side in the X direction. The position of an edge 511b of the antireflection film 511 on the X2 side in the X direction matches the position of an edge 3d of the counter substrate 3 on the X2 side in the X direction. This is the same for any edge in the Y direction or an oblique direction to the X and Y directions.

The light source 620 is disposed on the Z1 side (lower side) relative to the panel unit 110. The light source 620 is a light source including a light emitting element such as a light emitting diode (LED) but is not limited thereto and may be a typical light source used for illumination.

As illustrated in FIG. 5A, a flexible printed circuit (FPC) 400 is coupled to a terminal group (for example, the second terminal group 20) of the array substrate 2 in each of the light adjustment panels 1A, 1B, 1C, and 1D.

As described above, the optical sheets 5 are bonded to the back surface 3b of the counter substrate 3 of the first light adjustment panel (light adjustment panel 1A) positioned furthest to the upper side (one side in the first direction) and to the back surface 2b of the array substrate 2 of the second light adjustment panel (light adjustment panel 1D) positioned furthest to the lower side.

In a case where the light adjustment device 100 is installed at a high place such as a ceiling, an uppermost or lowermost site of the panel unit 110 typically hits a floor surface when the light adjustment device 100 falls. The optical sheets 5 are bonded to the upper side of the light adjustment panel 1A disposed furthest to the upper side in the panel unit 110 and the lower side of the light adjustment panel 1D disposed furthest to the lower side in the panel unit 110. Thus, even when the light adjustment device 100 is damaged from impact of fall, scattering of damaged components can be suppressed with the optical sheets 5 and bonding layers (for example, the first bonding layers 71 and the second bonding layers 72).

When the third light adjustment panel and the fourth light adjustment panel are two light adjustment panels adjacent to each other in the Z direction (first direction) among the plurality of light adjustment panels, the second bonding layer (bonding layer) 72 that joins the counter substrate 3 of the third light adjustment panel and the array substrate 2 of the fourth light adjustment panel is provided. The second bonding layer 72 is provided on the entire surface of the counter substrate 3 of the third light adjustment panel and the entire surface of the array substrate 2 of the fourth light adjustment panel. More specifically, as illustrated in FIG. 5A, the second bonding layer 72 is provided on the entire surface of the array substrate 2 of the third light adjustment panel, and the second bonding layer 72 is present below an end part of the third light adjustment panel such that the end part of the third light adjustment panel faces an end part of the fourth light adjustment panel through the second bonding layer 72. The other light adjustment panels and the corresponding second bonding layer 72 have the same relation. The second bonding layers 72 are cured in a manufacturing process and thus are not used in an uncured state nor bonded to an end part of a light adjustment panel or the FPC when used.

Accordingly, scattering of pieces of substrates and the like is further suppressed when, for example, the light adjustment device 100 falls and cracks occur to any light adjustment panel. In particular, since the array substrate 2 is larger than the counter substrate 3, the end part 2d of the array substrate 2 protrudes in the X direction from an end of the counter substrate 3 but is provided with the second bonding layer 72. Thus, scattering of pieces of substrates and the like when cracks occur to the frame region such as terminal parts is further suppressed as compared to an aspect in which no second bonding layer 72 is provided at the end part 2d of the array substrate 2.

The optical sheets 5 include the antireflection films 511 and 512. As illustrated in FIG. 5A, the light source 620 is disposed on the Z1 side (lower side) relative to the second light adjustment panel (light adjustment panel 1D). Specifically, light 621 emitted from the light source 620 enters the panel unit 110 from the light adjustment panel 1D side. Since the antireflection film 512 is bonded to the light adjustment panel 1D, reflection of the light 621 toward the Z1 side is suppressed and the amount of the light 621 toward the Z2 side (upper side) increases. The light 621 traveling inside the panel unit 110 toward the Z2 side (upper side) is output from the light adjustment panel 1A. In this case as well, since the antireflection film 511 is bonded to the light adjustment panel 1A, reflection of the light 621 toward the Z1 side is suppressed and the amount of the light 621 output from the Z2 side (upper side) increases.

The edges of each optical sheet 5 are provided along the edges of a surface of a substrate to which the optical sheet 5 is bonded. With this configuration, the optical sheet 5 is bonded to the substrate in a large area. Thus, the amount of scattering of damaged components when the light adjustment device 100 is damaged from impact of fall is further reduced. Moreover, since the antireflection film 512 has a larger area, the amount of the light 621 with reduced reflection can be increased.

### Modification

The following describes a modification of the first embodiment. FIG. 5B is a schematic diagram illustrating a section of a light adjustment device according to the modification. This light adjustment device 100A illustrated in FIG. 5B is different from the light adjustment device 100 illustrated in FIG. 5A in the position of the end part 2d of each array substrate 2. Specific description is given below.

As illustrated in FIG. 5B, the panel unit 110 is formed by stacking a plurality of light adjustment panels 1 in the Z direction (first direction). Specifically, four light adjustment panels 1 illustrated in FIG. 1 are stacked. The four light adjustment panels 1 are light adjustment panels 1A, 1B, 1C, and 1D stacked in order from the upper side. In the light adjustment panel 1A, the end part 2d of the array substrate 2 is positioned at an end on the X1 side like FIG. 5A. In the light adjustment panel 1B, the end part 2c of the array substrate 2 is positioned at an end on the X2 side unlike FIG. 5A. In the light adjustment panel 1C, the end part 2d of the array substrate 2 is positioned at an end on the X1 side like FIG. 5A. In the light adjustment panel 1D, the end part 2c of the array substrate 2 is positioned at an end on the X2 side unlike FIG. 5A. In other words, the positions of the end parts 2c and 2d of the array substrates 2 in the X direction in the light adjustment panels alternate between the X1 and X2 sides in order of stacking.

All light adjustment panels adjacent to each other in the Z direction are bonded to each other through the second bonding layer (bonding layer) 72. Each second bonding layer 72 is provided across the entire surface of a substrate (the array substrate 2 or the counter substrate 3) in each of the light adjustment panels 1A, 1B, 1C, and 1D. For example, in the light adjustment panel 1B (fourth light adjustment panel), the second bonding layer 72 is provided on the entire surface of the back surface 2b of the array substrate 2. Specifically, the second bonding layer 72 is provided from the end of the back surface 2b of the array substrate 2 on the X2 side to the end on the X1 side in the X direction and from the end of the back surface 2b of the array substrate 2 on the Y2 side to the end on the Y1 side in the Y direction. In the light adjustment panel 1C (third light adjustment panel), the second bonding layer 72 is provided on the entire surface of the back surface 3b of the counter substrate 3. Specifically, the second bonding layer 72 is provided from the end of the back surface 3b of the counter substrate 3 on the X2 side to the end on the X1 side in the X direction and from the end of the back surface 3b of the counter substrate 3 on the Y2 side to the end on the Y1 side in the Y direction. In this manner, the second bonding layers 72 are provided on the entire surface of the counter substrate 3 of the third light adjustment panel and the entire surface of the array substrate 2 of the fourth light adjustment panel.

As described above, in the modification as well, when the third light adjustment panel and the fourth light adjustment panel are two light adjustment panels adjacent to each other in the Z direction (first direction) and the fourth light adjustment panel is disposed on the Z2 side (one side in the first direction) relative to the third light adjustment panel, the second bonding layer 72 is provided on the entire surface of the counter substrate 3 of the third light adjustment panel and the entire surface of the array substrate 2 of the fourth light adjustment panel.

Accordingly, scattering of pieces of substrates and the like is further suppressed when, for example, the light adjustment device 100A falls and cracks occur to any light adjustment panel. In particular, since the array substrate 2 is larger than the counter substrate 3, the end parts 2c and 2d of the array substrate 2 protrude in the X direction from an end of the counter substrate 3 but is provided with the second bonding layer 72. Thus, scattering of pieces of substrates and the like when cracks occur to the frame region such as terminal parts is further suppressed as compared to an aspect in which no second bonding layer 72 is provided at the end parts 2c and 2d of the array substrate 2.

### Second Embodiment

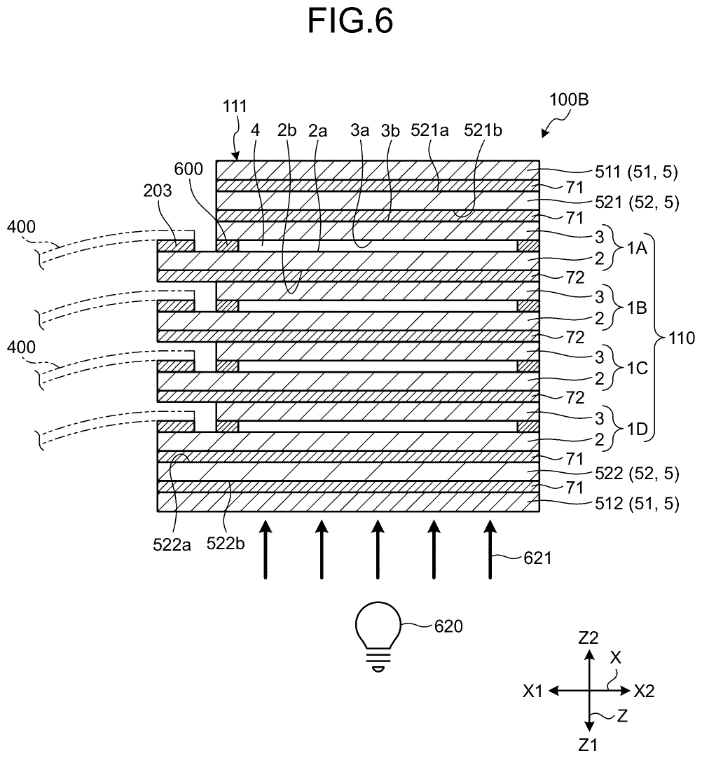

The following describes a light adjustment device according to a second embodiment. FIG. 6 is a schematic diagram illustrating a section of the light adjustment device of the second embodiment. This light adjustment device 100B according to the second embodiment further includes triacetyl cellulose (TAC) films 52 in addition to the configuration of the light adjustment device 100 according to the first embodiment. Detailed description is given below.

In the second embodiment, the optical sheets 5 include the antireflection films 51 and the triacetyl cellulose films 52. Each of the antireflection films 51 and a corresponding one of the triacetyl cellulose films 52 are provided in a stacked state in the panel unit 110.

A triacetyl cellulose film 521 is bonded to the back surface 3b of the counter substrate 3 in the light adjustment panel 1A through the first bonding layer 71. In other words, a lower surface 521b of the triacetyl cellulose film 521 is bonded to the back surface 3b of the counter substrate 3 through the first bonding layer 71. The antireflection film 511 is bonded to an upper surface 521a of the triacetyl cellulose film 521 through another first bonding layer 71.

A triacetyl cellulose film 522 is bonded to the back surface 2b of the array substrate 2 in the light adjustment panel 1D through the first bonding layer 71. In other words, an upper surface 522a of the triacetyl cellulose film 522 is bonded to the back surface 2b of the array substrate 2 through the first bonding layer 71. The antireflection film 512 is bonded to a lower surface 522b of the triacetyl cellulose film 522 through another first bonding layer 71.

As described above, in each optical sheet 5, the antireflection film 51 and the triacetyl cellulose film 52 are stacked. The triacetyl cellulose film 52 is positioned on the substrate side, and the antireflection film 51 is positioned on a side opposite the substrate with respect to the triacetyl cellulose film 52.

With this configuration, an ultraviolet component of the light 621 can be reduced through the triacetyl cellulose film 52. Accordingly, degradation of the light adjustment panels 1 due to the ultraviolet component can be suppressed.

### Third Embodiment

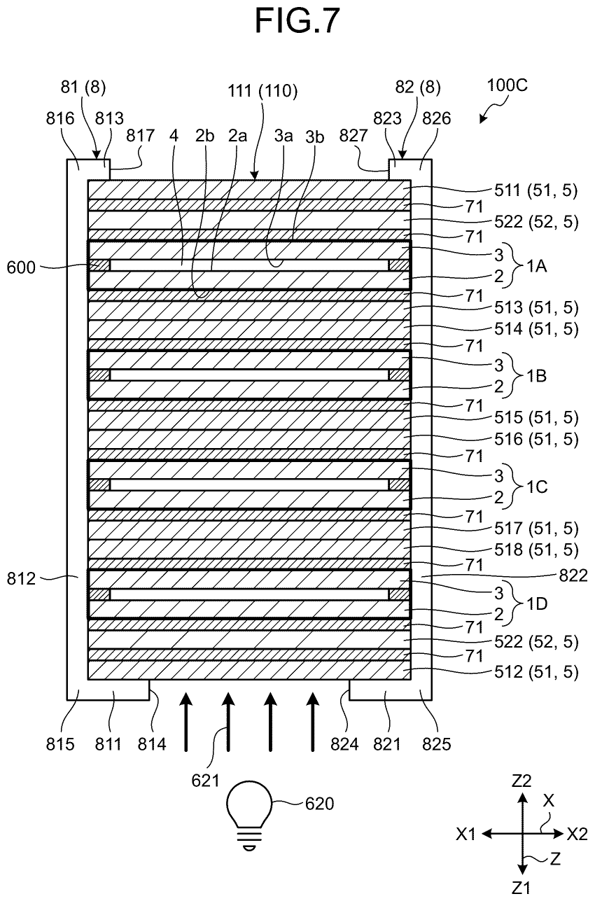

The following describes a light adjustment device according to a third embodiment. FIG. 7 is a schematic diagram illustrating a section of the light adjustment device of the third embodiment. A light adjustment device 100C according to the third embodiment is different from the light adjustment device 100B according to the second embodiment in that antireflection films are provided on the stacked light adjustment panels and the device body (the panel unit and the optical sheets) is held with a frame. Detailed description is given below.

An antireflection film 513 is bonded to the back surface 2b of the array substrate 2 in the light adjustment panel 1A through the first bonding layer 71. An antireflection film 514 is bonded to the back surface 3b of the counter substrate 3 in the light adjustment panel 1B through another first bonding layer 71. These antireflection films 513 and 514 face each other in the Z direction. Although a configuration in which a bonding layer is provided between the antireflection films 513 and 514 to bond the films can be employed, the films have no bonding layer therebetween and are simply stacked in the present embodiment.

An antireflection film 515 is bonded to the back surface 2b of the array substrate 2 in the light adjustment panel 1B through the first bonding layer 71. An antireflection film 516 is bonded to the back surface 3b of the counter substrate 3 in the light adjustment panel 1B through another first bonding layer 71. These antireflection films 515 and 516 face each other in the Z direction. Although a configuration in which a bonding layer is provided between the antireflection films 515 and 516 to bond the films can be employed, the films have no bonding layer therebetween and are simply stacked in the present embodiment.

An antireflection film 517 is bonded to the back surface 2b of the array substrate 2 in the light adjustment panel 1C through the first bonding layer 71. An antireflection film 518 is bonded to the back surface 3b of the counter substrate 3 in the light adjustment panel 1D through another first bonding layer 71. These antireflection films 517 and 518 face each other in the Z direction. Although a configuration in which a bonding layer is provided between the antireflection films 517 and 518 to bond the films can be employed, the films have no bonding layer therebetween and are simply stacked in the present embodiment.

The device body 111 including the panel unit 110 and the optical sheets 5 is held by a frame 8. The frame 8 includes a first frame 81 and a second frame 82. The first frame 81 holds a site of the device body 111 on the X1 side. The second frame 82 holds a site of the device body 111 on the X2 side.

The first frame 81 includes a second leg part 811, a frame body part 812, and a first leg part 813. The second leg part 811 extends in the X direction. The second leg part 811 extends from an end 814 to an end 815. The frame body part 812 extends in the Z direction from the end 815 to an end 816. The first leg part 813 extends in the X direction from the end 816 to an end 817. The first frame 81 has a substantially U-shaped section.

The second frame 82 includes a second leg part 821, a frame body part 822, and a first leg part 823. The second leg part 821 extends in the X direction. The second leg part 821 extends from an end 824 to an end 825. The frame body part 822 extends in the Z direction from the end 825 to an end 826. The first leg part 823 extends in the X direction from the end 826 to an end 827. The second frame 82 has a substantially U-shaped section.

In other words, the frame 8 includes the frame body parts 812 and 822 provided at a side part of the device body 111 (end part thereof in the second direction intersecting the first direction) and extending in the up-down direction, the first leg parts 813 and 823 extending in the X direction (second direction) from the frame body parts 812 and 822 along an upper end part of the device body 111 (end part thereof on the one side in the first direction), and the second leg parts 811 and 821 extending in the X direction (second direction) from the frame body part 812 along a lower end part of the device body 111 (end part thereof on the other side in the first direction).

Each first bonding layer 71 is provided on the entire surface of the array substrate 2. Specifically, the first bonding layer 71 is provided in the X direction from an end of the array substrate 2 on the X2 side to an end thereof on the X1 side. More specifically, the first bonding layer 71 is provided on the entire surface of the array substrate 2, entirely covering the effective region through which light transmits as well as the frame region such as terminal parts. The antireflection films 511, 512, 513, 514, 515, 516, 517, and 518 are each provided in the X direction from the end of the array substrate 2 or the counter substrate 3 on the X2 side to the end thereof on the X1 side. More specifically, each antireflection film on the array substrate 2 side has the same size as the array substrate 2 in a plan view and is bonded to the entire surface of the array substrate 2. Similarly, each antireflection film on the counter substrate 3 side has the same size as the counter substrate 3 in a plan view and is bonded to the entire surface of the counter substrate 3.

As described above, the light adjustment device 100B according to the third embodiment further includes the frame 8 that holds the device body 111 including the panel unit 110 and the optical sheets 5. The frame 8 includes the frame body part 812 extending in the up-down direction, the first leg part 813, and the second leg part 811.

The device body 111 can be held with the frame 8 even when the plurality of light adjustment panels 1 included in the panel unit 110 are not bonded to each other. Thus, transparent bonding layers that bond the plurality of light adjustment panels 1 are unnecessary. Accordingly, transmittivity of the light 621 through the panel unit 110 increases and cost can be reduced.

Moreover, since the antireflection films 51 are bonded to the respective light adjustment panels 1 in the panel unit 110, reflection of the light 621 to the Z1 side (lower side), the light 621 traveling toward the Z2 side (upper side) in the panel unit 110, is suppressed and the amount of the light 621 output from the Z2 side (upper side) increases.

In the first terminal group 10 and the second terminal group 20 (terminal groups) provided on the array substrate 2, the first terminal 101, the second terminal 102, the third terminal 103, and the fourth terminal 104 (terminals) included in the first terminal group 10 are electrically coupled to the fifth terminal 201, the sixth terminal 202, the seventh terminal 203, and the eighth terminal 204 (terminals) included in the second terminal group 20.

Thus, the flexible printed circuit 400 can be coupled to any of the first terminal group 10 and the second terminal group 20.

The array substrate 2 is shaped in an octagon that has the first side 211 and the second side 212 intersecting the first side 211 (in a polygon having four or more sides). The terminal groups are provided at the first end part 21 provided at an end part along the first side 211 of the array substrate 2 and closer to the second side 212 with respect to the center of the first side 211, and the second end part 22 provided at an end part along the second side 212 and closer to the first side 211 with respect to the center of the second side 212. The first terminal group 10 is provided at the first end part 21, and the second terminal group 20 is provided at the second end part 22.

With this configuration, the first terminal groups 10 or the second terminal groups 20 coupled to the flexible printed circuit 400 can be disposed on the Y1 side or the Y2 side through simple work of rotating the light adjustment panels 1A, 1B, 1C, and 1D having the same structure.

The wire (first wire) 241 and the wires (fourth wires) 249 and 251 on the array substrate 2 are electrically coupled to wires on the counter substrate 3 stacked on the array substrate 2 through a conductive pillar. Thus, conduction between the wires on the array substrate 2 and the wires on the counter substrate 3 is provided with a simple structure.

Although some embodiments of the present invention are described above, these embodiments are presented as examples and not intended to limit the scope of the invention, and each configuration may be modified as appropriate without departing from the scope of the invention. For example, the thickness of each above-described bonding layer is preferably 50 μm to 500 μm, more preferably 100 μm to 250 μm, to prevent scattering of pieces at falling. In a normal liquid crystal display panel, the thickness of a bonding layer through which a polarization plate is bonded to a liquid crystal panel is 25 μm approximately, and thus the thickness of each bonding layer in the present embodiment is sufficiently larger than that of the bonding layer in the liquid crystal display panel.

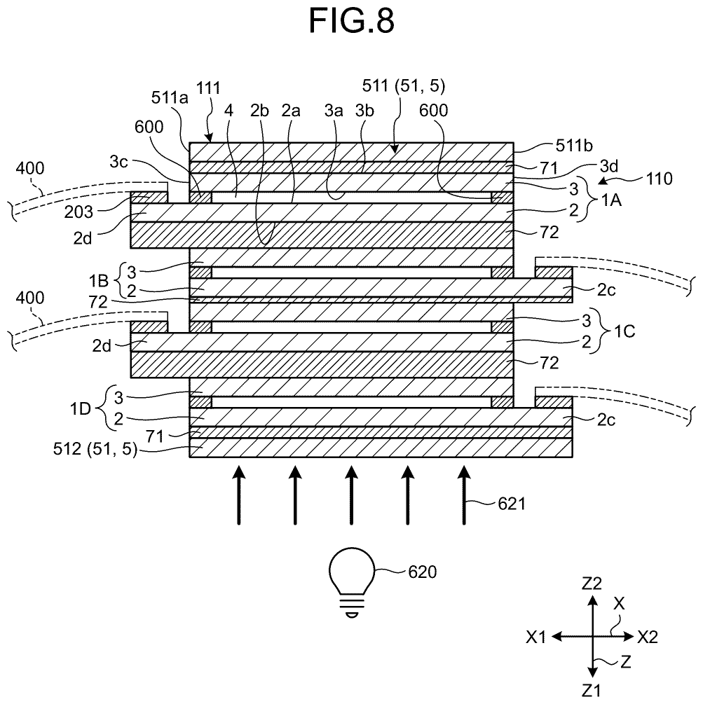

A configuration in which the thickness of each bonding layer is changed as appropriate may be employed. More specifically, an aspect in which the thickness of a site positioned on the inner side when viewed in the thickness direction (first direction) among the second bonding layers 72 is smaller than the thickness of a site positioned on the outer side may be employed as illustrated in FIG. 8. In other words, the aspect is such an aspect that, for example, the thickness of the second bonding layer 72 provided at a site where the counter substrate 3 of the light adjustment panel 1C and the array substrate 2 of the light adjustment panel 1B overlap each other is smaller than the thickness of another second bonding layer 72 provided on the outer side (outer side in the thickness direction) thereof when viewed in the Z direction.

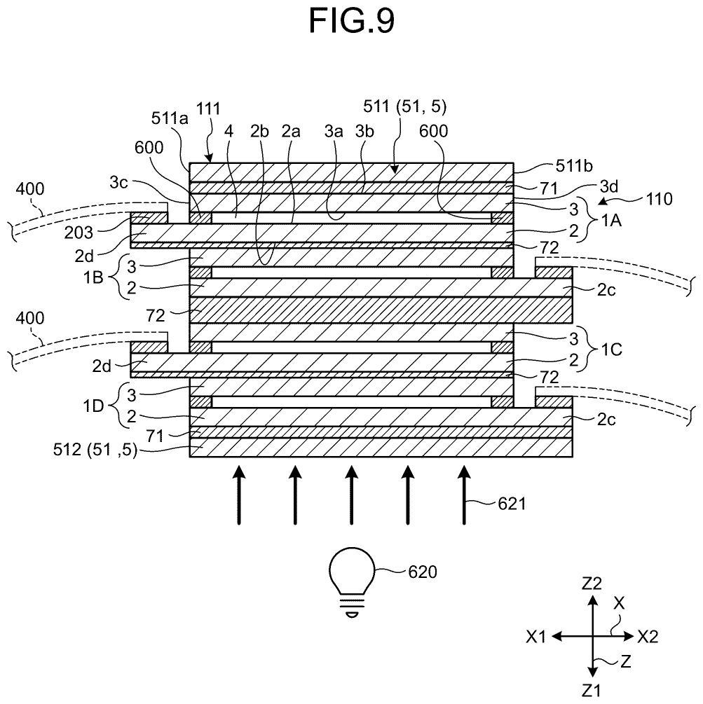

Alternatively, a configuration in which the thickness of a second bonding layer 72 positioned on the inner side among the second bonding layers 72 is larger than the thickness of another second bonding layer 72 positioned on the outer side as illustrated in FIG. 9 may be employed. In other words, the configuration is such an aspect that, for example, the thickness of the second bonding layer 72 provided at a site where the counter substrate 3 of the light adjustment panel 1C and the array substrate 2 of the light adjustment panel 1B overlap each other is larger than the thickness of another second bonding layer 72 provided on the outer side (outer side in the thickness direction) thereof when viewed in the Z direction. With this configuration, resistance against heat from the light source 620 can be increased and resistance against ultraviolet from a light outputting side can be increased.

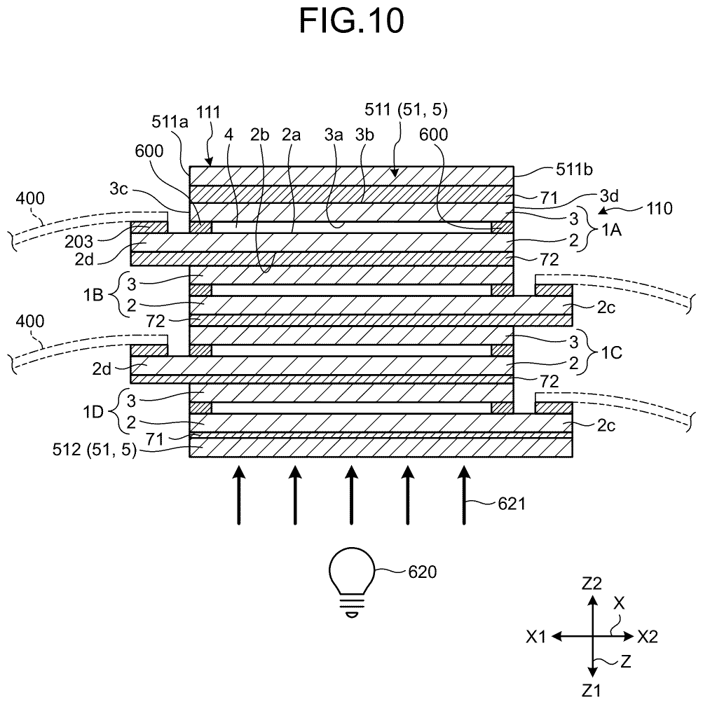

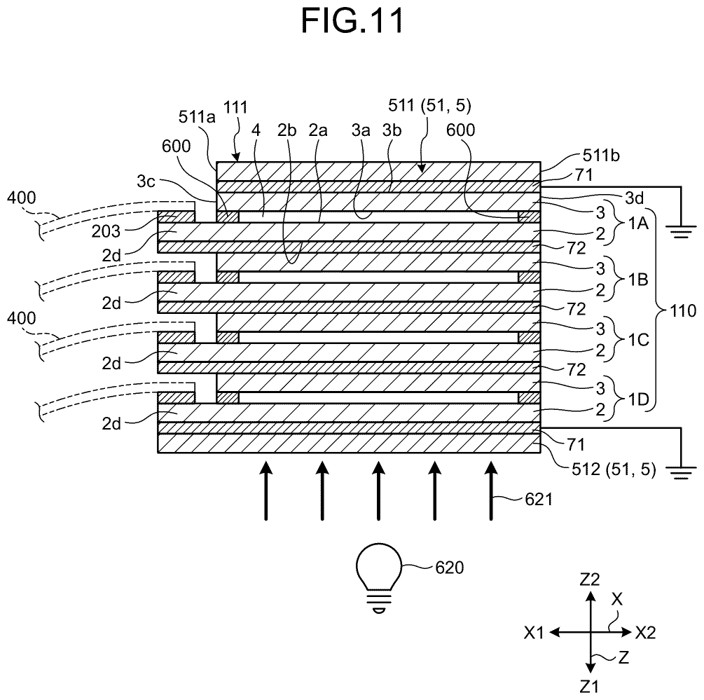

Moreover, a configuration in which bonding layers are gradually thicker from the light source 620 side toward the light outputting side may be employed (refer to FIG. 10). Conductivity may be provided only to a bonding layer positioned furthest to the outer side in the thickness direction among the above-described bonding layers, or a configuration in which conductivity is provided to all bonding layers may be employed. As illustrated in FIG. 11, a configuration in which the bonding layers having conductivity are coupled to a wire or the like having GND potential may be employed. Entrance of static electricity from the outside to conductive layers of the light adjustment panels can be suppressed.

What is claimed is:

1. A light adjustment device comprising:
a panel unit in which a plurality of light adjustment panels each including a first substrate and a second substrate overlapping the first substrate on one side in a first direction intersecting the first substrate are stacked in the first direction;
an optical sheet bonded to the light adjustment panels in a state of overlapping the light adjustment panels; and
a light source positioned on another side relative to the panel unit in the first direction, wherein
the optical sheet is bonded to at least one of the second substrate of a first light adjustment panel positioned furthest to the one side in the first direction in the panel unit and the first substrate of a second light adjustment panel positioned furthest to the other side in the first direction.

2. The light adjustment device according to claim 1, wherein the optical sheet includes an antireflection film.

3. The light adjustment device according to claim 1, wherein edges of the optical sheet are provided along edges of a substrate to which the optical sheet is bonded.

4. The light adjustment device according to claim 2, wherein the antireflection film is bonded in a state of overlapping at least one of the first substrate and the second substrate in one of the light adjustment panels included in the panel unit.

5. The light adjustment device according to claim 1, further comprising a frame that holds a device body including the panel unit and the optical sheet, wherein
the frame includes
a frame body part that is provided at an end part of the device body in a second direction intersecting the first direction and extends in the first direction,
a first leg part extending in the second direction from the frame body part along an end part of the device body on the one side in the first direction, and
a second leg part extending in the second direction from the frame body part along an end part of the device body on the other side in the first direction.

6. The light adjustment device according to claim 1, wherein
two or more terminal groups are provided at the first substrate, and terminals included in one of the terminal groups are electrically coupled to terminals included in another one of the terminal groups,
the first substrate includes a first side and a second side intersecting the first side and is shaped in a polygon having four or more sides, and
the terminal groups are provided at
a first end part of an end part along the first side of the first substrate, the first end part being on a side closer to the second side with respect to a center of the first side, and
a second end part of an end part along the second side, the second end part being provided on a side closer to the first side with respect to a center of the second side.

7. The light adjustment device according to claim 1, wherein each of the light adjustment panels includes a liquid crystal layer between the first substrate and the second substrate.

8. A panel unit in which
a plurality of light adjustment panels each including a first substrate and a second substrate overlapping the first substrate on one side in a first direction intersecting the first substrate are stacked in the first direction,
the first substrate is formed larger than the second substrate in a plan view,
the plurality of light adjustment panels include a third light adjustment panel and a fourth light adjustment panel adjacent to each other in the first direction, and the fourth light adjustment panel is disposed on one side relative to the third light adjustment panel in the first direction,
the panel unit includes a bonding layer that joins the second substrate of the third light adjustment panel and the first substrate of the fourth light adjustment panel, and
the bonding layer is provided on an entire surface of the first substrate of the fourth light adjustment panel.

9. The panel unit according to claim 8, wherein
a second direction is a direction intersecting the first direction,
an end part of one of the first substrate and the second substrate further protrudes in the second direction than another, and
the bonding layer is provided at the end part.

10. The panel unit according to claim 8, wherein the first substrate has a regular polygonal shape, and the second substrate has a shape obtained by removing part of the regular polygonal shape and has one side or a plurality of sides with a length matching at least one side or a plurality of adjacent sides constituting an outer edge of the first substrate.

11. The panel unit according to claim 9, wherein when viewed in the first direction, thickness of the bonding layer provided at a site where the second substrate of the third light adjustment panel and the first substrate of the fourth light adjustment panel overlap each other is smaller than thickness of the bonding layer provided at the end part.

12. The panel unit according to claim 9, wherein when viewed in the first direction, thickness of the bonding layer provided at a site where the second substrate of the third light adjustment panel and the first substrate of the fourth light adjustment panel overlap each other is larger than thickness of the bonding layer provided at the end part.

13. The panel unit according to claim 8, wherein
the light adjustment panels adjacent to each other in the first direction among the plurality of light adjustment panels are joined to each other through the bonding layer, and
the plurality of bonding layers are thicker toward the one side in the first direction.

14. The panel unit according to claim 8, wherein the bonding layer is at ground potential.
